(19) United States
(12) Patent Application Publication
(10) Pub. No.: US 2005/0178177 A1
(43) Pub. Date: Aug. 18, 2005

(54) Organo phosphatic fertilizer

(75) Inventors: Leon-Etienne Parent, St-Nicolas (CA); Suzanne Allaire, Ancienne-Lorette (CA); Lotfi Khiari, Ste-Foy (CA); Antoine Karam, Quebec (CA)

Correspondence Address: OGILVY RENAULT LLP, 1981 MCGILL COLLEGE AVENUE, SUITE 1600, MONTREAL, QC, H3A2Y3, CA

(73) Assignee: UNIVERSITE LAVAL, Quebec (CA)

(21) Appl. No.: 10/779,637

(22) Filed: Feb. 18, 2004

(51) Int. Cl. C05F 1/00

(52) U.S. Cl. 71/11

(57) ABSTRACT

The present invention relates to an organo phosphatic fertilizer and to method for preparing the same. The method comprises treating, and optionally dehydrating, mixing it to a mineral fertilizer in a proportion of 40% to 90% of pig manure for 10 to 60% of mineral fertilizer and pelletizing the mixture.

### TECHNICAL FIELD

The present invention relates to a pelletized organic mineral fertilizer that comprises at least 40 percent (w/w) of dehydrated and biotreated pig manure and up to 60 percent (w/w) of a mineral fertilizer. The present invention also relates to a method for preparing a the pig manure-based organo phosphatic fertilizer of the present invention.

### BACKGROUND OF THE INVENTION

The key macronutrients of a fertilizer are nitrogen (N), potassium (K) and phosporus (P). Although mineral fertilizers are good sources of compounds to provide a soil with those macronutrient, their efficacy is time limited. Indeed, in the immediate vicinity of a fertilizer pellet or granule of mineral fertilizer incorporated into the soil, the phosphorus fertilizer dissolved in a soil solution rapidly reacts with Fe, Al, or Ca compounds (Breeuwsma and Silva, 1992), hence decreasing fertilizer P availability to crops (Voykin et al., 1976). In particular, phosphorus is strongly retained in podzolized soils used for potato production (Khiari et al., 2000). Therefore, fertilizers able to slowly and gradually release P gained increasing interest over the last decades since they contribute to reduce the amount of fertilizer spread onto crops while maintaining a proper concentration of phosporus available to plants. The acidity or alcalinity of a soil also contributes to reduce the availability of P to plants (Edwards, 1991) and a pH ranging from 5.5 to 7.0 likely contributes to make P available.

The prior art reports that a combination of mineral and organic materials shows synergistic effects on the prevention of phosphorus binding by Fe, Al or Ca (Abbès et al., 1995). P fixation is reduced since organic materials contain functional groups such as —OH, —COOH and —SO₃H, that compete with orthophosphate ions for sorption sites in soils, thereby reducing phosphorus retention by Fe, Al or Ca (Fox et al. 1990; Hue 1991). As manure and plant residues are good sources of organic materials, their combination with mineral phosphorus, or their application prior the application of a mineral fertilizer were shown to enhance P solubility (MnKeni and MacKenzie 1985; Fox et al. 1990; Hue 1991; Staunton and Leprince 1996; lyamuremye and Dick 1996). Among organic materials effective against soil retention of P, organic acids and humic substances are particularly effective in preventing P precipitation by Al compounds (Singh and Jones 1976; Fox and Comerford 1990; lyamuremye et al. 1996). The reactive organic ligands are bi- and tri-carboxylic acids as well as high molecular-weight humic and fulvic acids (Stevenson 1986).

Although the application of organic matter may represent an interesting strategy to reduce P-fixation by Al, Fe or Ca ions, it does not alleviate reduced P availability attributed to soil pH conditions. For example, cow manure comprises a significant amount of alcaline cations that contribute to increase soil pH, which must be compensated by the application of lime (Hue, 1992; Mnkeni ans Mackenzie, 1985). At the opposite, peat has a very low pH (around 4.3). The acidic condition of this organic matter may lead to a decrease of its efficiency as fertilizer since plant roots tend to avoid acidic conditions. Since it represents a very good organic source for its relatively high humic acid content, prior art reports the ammoniation of peat by associating it to a nitrogen source and equilibrating it into a potassium chloride solution, so as to increase the pH and the presence of ammonium humates, therefore providing a slow nitrogen-release fertilizer (U.S. Pat. No. 5,749,934). Considering the state of the prior art, it become highly desirable to be provided with an organic matter having excellent soil neutralizing and buffering properties without the need of additional supplementation or treatment.

Among the known organic matter sources usable for the fabrication of an organic mineral fertilizer, pig manure represents one of the most interesting alternative. Indeed, phosphorus in pig manure has been associated for many years with ground water and surface water contamination. The potential for water resource contamination by phosphorus therefore requires the implementation of regional management of animal manures and redistribution of excess nutrients (Sharpley et al., 1998). Pelletization of pig manure produces a dry and light-weight added-value commercial material that is easy to handle, transport, and apply and thus contributes to alleviate management problems (Sharpley et al., 1998). However, before drying and pelletizing, the manure must be liquid-solid separated to concentrate the solids, then bio-treated to eliminate odors. Since bio-treatment and drying of manure lead to additional expense, the latter must be compensated by sale of the pelletized manure. The nutrient composition of pelletized manure alone being relatively low compared to mineral fertilizers, its commercialization is modest since the nutrient composition is the main contributor of the market value of a fertilizer. In addition to its poor nutrient capacity, a pellet made from manure alone may also be too light-weight for bulk blending with mineral fertilizers.

Patent application WO 02/0618 reports a method for producing an organic mineral fertilizer that comprises an organic material, such as biotreated pig manure, and urea are the nitrogen source. Although ammoniation of pig manure can occur due to the presence of urea, the general purpose of this organic fertilizer is most likely to provide a soil with nitrogen since urea is the principal component of the fertilizer. Indeed, the organic material is restricted to a 30% w/w content. Therefore, such an organic mineral fertilizer is exposed to have a macronutrient content that is inadequate to respect the industry standard of a certified organo phosphatic fertilizer. Moreover, since the needs for pig manure are relatively low for the production of this fertilizer, it does not represent a particularly good way to alleviate the pig manure management problem that has been encountered for many years. Finally, the high nitrogen content of the organic fertilizer reported in Patent application WO 02/0618 is not adequate for crops that have high phosphorus needs, such as corn and potatoes.

Considering the state of the prior art, there is a need for an organo-phosphatic fertilizer capable of solving pig manure management problems and having excellent soil neutralizing and buffering properties.

### SUMMARY OF THE INVENTION

The present invention relates to an organo phosphatic fertilizer that comprises 40% to 90% of treated pig manure and 10 to 60% of a mineral fertilizer. The present invention also relates to a method for managing pig manure. The method of the present invention comprises sequentially or concomitantly treating and dehydrating the pig manure, mixing the treated and dehydrated pig manure with a mineral fertilizer in a proportion of 40% to 90% of pig manure for 10 to 60% of mineral fertilizer and pelletizing the mixture obtained therefrom.

### BRIEF DESCRIPTION OF THE DRAWINGS

FIG. 1a to 1c are curves representing pH changes as a function of organic material concentrations in water.

FIG. 2 is a series of curves comparing the pH and buffering properties for different organic materials.

FIG. 3a to 3c are curves showing variations in the concentration of soluble phosphorus as a function of organic material concentrations in water.

FIG. 4 represents a phosphorus partitioning flowchart and pool designation.

FIG. 5 shows the increase in loosely bound P[Δ(LBP)] due to added P as related to soil groups and addition of dry swine manure (LIOR), wherein r(LBP) is ΔY/ΔX from the origin point of the curve.

FIG. 6 shows the increase in Al-sorbed P[Δ(SP_{Al})] due to added P as related to soil groups and addition of dry swine manure (LIOR), wherein r(SP_{Al}) is ΔY/ΔX from the origin point of the curve.

FIG. 7 shows the increase in Fe-sorbed P[Δ(SP_{Fe})] due to added P as related to soil groups, wherein r(SP_{Fe}) is ΔY/ΔX from the origin point of the curve.

FIG. 8 shows the increase in organic P[Δ(P_{org})] due to added P as related to soil groups and addition of lime or dry swine manure (LIOR).

FIG. 9 shows the increase in desorbed P[Δ(DP)] due to added P as related to soil groups and addition of dry swine manure (LIOR)n wherein r(DP) is ΔY/ΔX from the origin point of the curve.

FIG. 10 is a flowchart illustrating the quantification of phosphorus partitioning for LSOM (minus LIOR and HSOM plus LIOR (highest P treatment) of treatments.

FIG. 11 is a curve showing corn yield as a function of LIOR concentration.

FIGS. 12a and 12b are curves showing potato tuber yields as a function of P₂O₅/ha and LIOR concentration.

FIG. 13 is a curve showing the average of potato tubers with a diameter larger than 57 mm as a function of P₂O₅/ha.

FIG. 14 is a curve showing the soy grain yield as a function of LIOR concentration.

### MODES OF CARRYING OUT THE INVENTION

The present invention relates to a pig manure-based organo phosphatic fertilizer that comprises 40% to 90% (w/w) of treated pig manure and 10% to 60% (w/w) of a mineral fertilizer, and more preferably 50% to 80% (w/w) of said treated pig manure and 20% to 50% (w/w) of a mineral fertilizer. These proportions are preferred since they could contribute to significantly alleviate the problems related to management of pig manure while producing a fertilizer rich in phosphorus and capable of meeting the N—P—K requirements to be certified as an organo phosphatic fertilizer. Use of pig manure instead of another organic source alleviate the problem of pig manure management. By incorporating high concentrations of pig manure in the organic mineral fertilizer of the present invention, it facilitates the exportation of pig manure from region of high pig plant concentration to exterior zones. The method of the present invention therefore contribute to reduce the environmental drawbacks of phosphate over fertilization encountered for many years.

As used in the present description and claims, the term “treated pig manure” means that it has undergone a treatment known to those skilled in the art to stabilize it and make it odorless. The treated pig manure of the present invention may be obtained by aerobic treatment, anaerobic treatment, biofiltration, composting chemical treatment, thermal treatment or physico-chemical treatment. The purpose of treating the pig manure prior its use in the manufacture of a fertilizer is mainly to stabilize it and to makes it odorless. The treated pig manure may optionally be dehydrated prior to being mixed with the mineral fertilizer. However, treatment of the manure should not comprise the incorporation of structuring matter such as bark, for example, since it may prevent a proper pelletization of the organo phosphatic fertilizer.

The organo phosphatic fertilizer of the present invention is preferably a solid fertilizer and more preferably a pellet, a granule, a powder or a crumb. The pig manure is a high density organic matter and therefore, is easier to pelletize than low density matter, such as peat for example. In a preferred embodiment of the present invention, the organo phosphatic fertilizer may further comprise a binding agent that enhance pelletization. The binding agent may comprise a zeolite, a silica, an attapulgite clay, a bentonite, or a polymer. For example, the binding agent may be Cal-Ben™, Microsorb® LVM, Microsorb® RVM and Attagel®. Min-U-Gel® 200 is however preferred. Min-U-Gel® 200 is an attapulgite clay provided by ITC Minerals & Chemicals and available from Fluoridin, Inc. This product is currently used for the pelletization of a fertilizer including a binding agent for chicken and bovine manure. The binding agent is preferably added at a concentration ranging from 0% to 5% (w/w) and more preferably from 0.5% to 2% (w/w), so as to provide a proper binding of the organo phospatic fertilizer components while respecting the economical aspect of a fertilizer intended to be used on large surfaces. The physical and mechanical characteristics of the organo phosphatic fertilizer of the present invention are preferentially similar to those of known chemical fertilizers, making it easy to transport, store and spread.

The mineral fertilizer used for the purpose of the present invention may be any proper mineral fertilizer, but is preferably urea, monoammonium phosphate (MAP), diammonium phosphate (DAP), ammonia, magnesium sulfate, magnesium chloride, magnesium silicate, dolomite or chrysotyle. The presence of such fertilizers may contribute to the ammoniation of the organic matter and enhances the presence of soluble carbon and of slow-release P sources, such as struvite (NH₄MgPO₄-6H₂O).

The present invention will be more readily understood by referring to the following examples which are given to illustrate the invention rather than to limit its scope.

### EXAMPLE 1

### Properties of Different Sources of Organic Material

The prior art reports the combination of an organic material, such as peat, with a mineral fertilizer such as DAP and MAP, to create a synergy within a confined micro-environment rich in organic matter (OM) and favorable to the nutrition of plants. Mineral fertilizers have a wide range of pH and their combination with an organic material may significantly affect the pH of the resulting OMF. Indeed, some mineral fertilizer are acidic such as MCP (pH: 1.48), MAP (pH: 3.47) and MKP (pH: 3.99) while DAP (pH: 7.98) and DKP (pH: 10.1) are alkaline. The characteristics and fertilizing capabilities of the different organic sources remaining undetermined, we performed a systematic characterization of the mineral properties and binding, neutralizing and salinizing capabilities for dehydrated and biotreated pig manure (LIOR), composted bovine manure (CBV), composted chicken manure (CCM), composted sheep manure (CSM), composted leaves, bark and grass (CLBG), composted paper plant sludges (CPPS), peat and ammoniated peat (AP).

TABLE 1
Origin of the tested organic matters

| Organic Matter | Source |
|---|---|
| Dehydrated and biotreated pig manure | DE.C Technologies, Inc. |
| | Québec, Canada |
| Composted bovine manure | Les composts Fafard, Inc. |
| | Québec, Canada |
| Composted chicken manure | Les composts Fafard, Inc. |
| | Québec, Canada |
| Composted sheep manure | Les composts du Québec, Inc. |
| | Québec, Canada |
| Composted leaves, bark and grass | Les composts du Québec, Inc. |
| | Québec, Canada |
| Composted paper plant sludges | Les composts du Québec, Inc. |
| | Québec, Canada |
| Peat | Premier Tech, Inc. |
| | St-Henri, Canada |
| Ammoniated peat¹ | Premier Tech, Inc. |
| | St-Henri, Canada |

¹Ammoniated peat was obtained by treating peat with NH₄OH 14.53N, in a proportion of 30 ml NH₄OH for 114 g of peat, according to Abbès et al., 1994 and U.S. Pat. No. 5,749,934.

pH Determination

Since any method designated for the purpose of determining the pH value of organic fertilizers were known, the method reported by Lindsay et al. (1962) for pH determination of mineral fertilizer pH was adapted accordingly to the mineral saturation of each source of organic material. Indeed, mineral saturation of mineral fertilizer is easily achieved by observing the presence of unsolubilized material. Due to the particular nature of organic fertilizers, several of their components cannot be solubilized therefore avoiding the determination of saturation by the observance of precipitates.

To determine the organic matter/water ratio where the solutions pH was saturated, increasing amounts of every dried organic matter (see Table 1) were mixed with 70 mL of water in 250 mL polypropylene recipients, in duplicate, and agitated for forty-eight (48) hours at 300 rpm on a New-Brunswick type agitator. The amount of organic material mixed with water was determined according to the density of each organic material since it influences water retention and thus water available for further analyses. Samples were centrifuged at 10,409×g for 10 minutes and filtered on a 2.5 μm number 42 Whatman paper (Fisher Scientific, Nepean, ON, Canada). The pH determination was done as reported in the prior art for each sample.

TABLE 1
Density of the tested organic matter.

| | Organic | Density | Amount |
|---|---|---|---|
| | Matter | (Mg/m³ ) | (g/70 mL of water) |
| Low Density | Peat | 0.20 | 0, 3, 6, 9, 12, 15, 18 |
| | AP | 0.25 | 0, 3, 6, 9, 12, 15 |
| Medium Density | CSM | 0.29 | 0, 3, 6, 9, 12, 15, 18, 21, 24 |
| | CBM | 0.30 | 0, 3, 6, 9, 12, 15, 18, 21, 24 |
| | CCM | 0.38 | 0, 3, 6, 9, 12, 15, 18, 21, 24, 27, |
| | | | 30 |
| High Density | CLBG | 0.48 | 0, 5, 10, 15, 20, 25, 30, 35, 40 |
| | CPPS | 0.52 | 0, 5, 10, 15, 20, 25, 30, 35, 40 |
| | LIOR | 0.67 | 0, 5, 10, 15, 20, 25, 30, 35, 40 |

Results

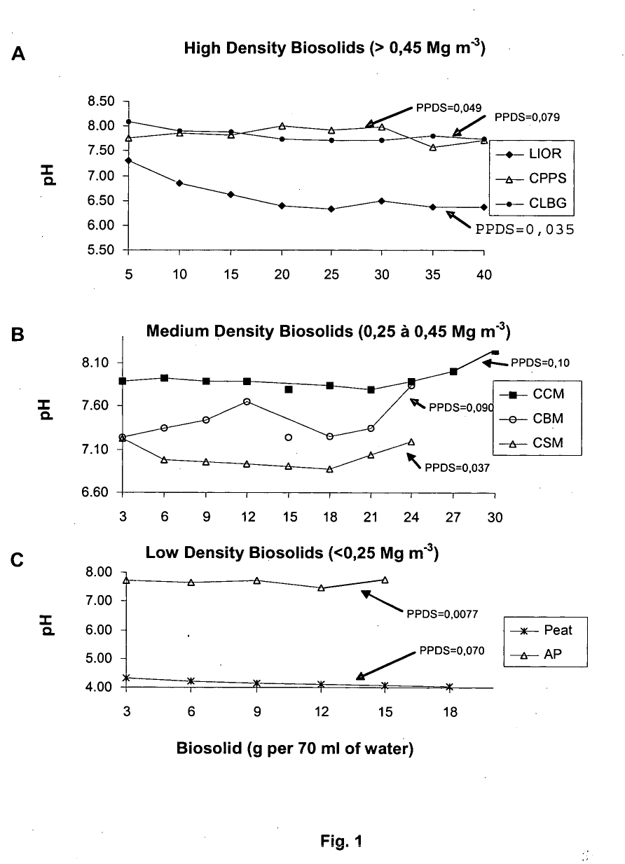

The pH decreases with increasing amount of organic matter until it reaches a critical ratio organic matter/water, which is specific for each substrate (FIG. 1 and Table 2). The acidification of the solution is attributable to increasing amounts of organic acids comprised in the organic matter. Interestingly, the pH increased with increasing amounts of CSM and CBM (FIG. 1). Having reached the critical organic matter/water ratio, the pH with LIOR, CSM, CBM and AP were 6.33, 6.91, 7.34 and 7.73, respectively. The pH of these organic materials is therefore approximately neutral, at the opposite of peat which have an acidic pH of 4.13. Therefore, LIOR, CSM, CBM and AP would be more appropriate for the production of an organic mineral fertilizer than untreated peat.

TABLE 2
pH at saturation

| | | | Organic Matter/Water ratio at saturation |
|---|---|---|---|
| Organic | Density | | level |
| Matter | (Mg/m) | pH | (g per 70 ml of water) |
| LIOR | 0.67 | 6.33 | 25 |
| CPPS | 0.52 | 7.99 | 9 |
| CLBG | 0.48 | 7.74 | 20 |
| CCM | 0.38 | 7.84 | 18 |
| CBM | 0.30 | 7.34 | 21 |
| CSM | 0.29 | 6.91 | 15 |
| Peat | 0.2 | 4.13 | 9 |
| AP | 0.25 | 7.73 | 9 |

Determination of Buffering Properties

To determine the buffering capacities of the different organic matters, we combined two methods previously reported by Magdoff and Bartlettt (1987) and Bruce and Riha (1986). Briefly, we placed 1 g of the different dried organic matters into a fifty (50) mL polypropylene centrifuge tube. Twenty-five (25) mL of a solution comprising 0, 5, 10, 15, 20 or 25 mL 0.0025M H₂SO₄ or 0.025M NaOH were added to the organic matter and the solutions were agitated for 22 hours at 300 rpm on a New-Brunswick type shaker (Fisher Scientific, Nepean, ON, Canada). Samples were centrifuged for ten (10) minutes at 38,724 g. Supernatants were filtered on a <8 μm Whatman number 40 paper (Fisher Scientific, Nepean, ON, Canada) and the pH was monitored as reported in the art.

Results

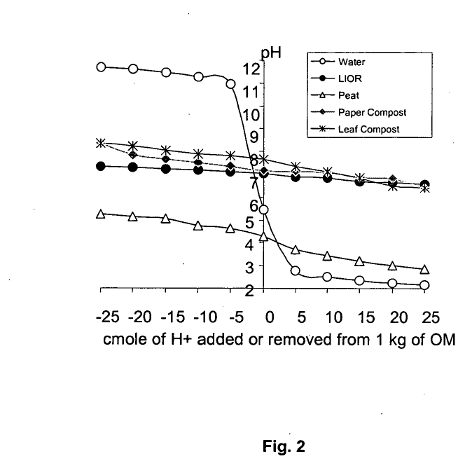

Results show that LIOR has the most stable pH and therefore, has the best burffering capacities (FIG. 2). According to this method LIOR has a pH of 6.98, which is the closest to neutrality. LIOR could therefore be used with any acidic or alkaline mineral fertilizer. Peat has a lower pH and therefore is less adequate to be used as organic matter component in a organic mineral fertilizer, unless being treated to increase its alkalinity.

Physico-Chemical Properties of Organic Matters

Each organic matter was treated with perchloric and nitric acids, according to Barhnisel and Bertsch (1982). Phosporus was quantified according to the vanado-molybdate method (Tandon et al., 1967). The different components of organic matter were quantified as known in the prior art.

Results

Table 3 shows the components of the different organic matters. Results of the physico-chemical analysis underline that LIOR has the highest content in macronutrients, namely nitrogen, phosphorus and potassium, with concentrations of 34.9, 41.5 and 72.8 g/kg of biomass, respectively. Particularly, the phosphorus concentration is nearly 2-folds higher in LIOR than in CCM (see Table 3), which is the second most concentrated organic matter in phosphorus.

Saturation in Soluble Organic Carbon (SOC)

The method for determining the saturation in soluble organic carbon of the different organic matters was performed as described for the determination of pH saturation. The measurement of SOC is known in the art.

TABLE 3
Chemical properties of the tested biosolids.

| | Peat | LIOR | CBM | CCM | CSM | CLBG | CPPS | AP |
|---|---|---|---|---|---|---|---|---|
| | g kg⁻¹ | | | | | | | |
| M.O. | 986 | 393 | 757 | 683 | 728 | 489 | 425 | 955 |
| M.S. | 918 | 923 | 818 | 783 | 934 | 940 | 953 | 878 |
| C | 572 | 228 | 439 | 396 | 422 | 284 | 247 | 554 |
| Ntotal | 15.8 | 34.9 | 19.5 | 32.2 | 18.4 | 14.2 | 6.5 | 30.9 |
| NH₄—N | 14.5 | 2.8 | 2.5 | 30.3 | 0.8 | 11.2 | 0.4 | 29.1 |
| NO₃—N | 1.3 | 32.1 | 17.0 | 1.9 | 17.6 | 3.0 | 6.1 | 1.8 |
| P | 0.6 | 41.5 | 2.4 | 20.7 | 7.4 | 2.4 | 1.4 | 0.04 |
| K | 0.1 | 72.8 | 7.2 | 12.8 | 11.0 | 9.2 | 2.0 | 0.1 |
| Ca | 0.0 | 17.9 | 22 | 10.1 | 13.9 | 13.4 | 17.9 | 2.6 |
| Mg | 0.2 | 20.1 | 2.6 | 5.0 | 5.1 | 3.7 | 2.6 | 0.5 |
| S | 0.7 | 0.8 | 3.6 | 1.8 | 2.9 | 0.6 | 0.4 | 2.1 |
| Na | 0.03 | 32.37 | 3.11 | 4.02 | 2.60 | 0.26 | 1.10 | 0.15 |
| | mg kg⁻¹ | | | | | | | |
| Al (ppm) | 1396 | 973 | 2532 | 2999 | 4958 | 9689 | 23356 | 923 |
| Fe (ppm) | 567 | 6235 | 2089 | 3016 | 5669 | 8559 | 7613 | 684 |
| Mn (ppm) | 15 | 999 | 101 | 289 | 420 | 579 | 295 | 15 |
| Cu (ppm) | 10 | 912 | 19 | 99 | 143 | 31 | 130 | 4 |
| Zn (ppm) | 57 | 2040 | 69 | 270 | 376 | 144 | 275 | 37 |
| Cr (ppm) | 3.5 | 165.3 | 4.3 | 5.2 | 8.9 | 13.2 | 6.2 | 0.4 |
| Pb (ppm) | 1.1 | 0.3 | 1.4 | 1.9 | 3.4 | 20.7 | 31.7 | 0.3 |
| Mo (ppm) | 0.4 | 35.2 | 1.4 | 2.9 | 2.3 | 0.7 | 2.4 | 0.1 |
| Co (ppm) | 0.6 | 7.9 | 1.2 | 1.7 | 3.3 | 4.1 | 5.0 | 0.2 |
| Ni (ppm) | 4.0 | 143 | 6 | 10 | 12 | 10 | 14 | 1 |
| As (ppm) | 0.9 | 2.1 | 3.5 | 8.7 | 2.0 | 3.8 | 2.9 | 0.8 |
| Cd (ppm) | 0.2 | 0.7 | 0.1 | 0.3 | 0.3 | 0.5 | 0.8 | 0.1 |
| | Without unit | | | | | | | |
| pH water | 4.13 | 6.33 | 7.34 | 7.84 | 6.91 | 7.74 | 8.00 | 7.73 |
| | dS m⁻¹ | | | | | | | |
| CE | 0.17 | 20.19 | 6.68 | 11.04 | 8.25 | 3.95 | 2.58 | 2.58 |
| Category | C1*P1** | C2PI | C1P1 | C1P1 | C2P1 | C1P1 | C2P1 | C1P1 |

C1 means any restriction on the use of the biosolid regarding to its content in inorganic contaminants.
C2 means some restriction on the use of the biosolid since some inorganic contaminants are over environmental standards.
P1 means any restriction on the use of the biosolid regarding to pathogen contaminants.

Results

Table 4 shows the organic matter/water ratio corresponding to saturation in SOC and the corresponding SOC concentration. The highest ratio was obtained with LIOR, with 9,900 mg/L, followed by chicken manure (6,800 mg/L) and ammoniated peat (approximately 6,300 mg/L). LIOR therefore represents an excellent source of binding agent that contributes to increase the availability of phosphorus within the micro-environment of a pellet, by competing with Al, Fe and Ca. Since LIOR has the highest SOC ratio, it is likely the best competitor of Fe, AL and Ca for phosphorus binding in a soil.

TABLE 4
Soluble Organic Carbon (SOC) concentration at saturation.

| | | Concentration of SOC at | Biosolid/water |
|---|---|---|---|
| Organic | Density | the plateau | ratio at saturation |
| Matter | (Mg/m³ ) | (mg/L) | (g per 70 ml of water) |
| LIOR | 0.67 | 9,900 | 25 |
| CBP | 0.52 | 165 | 23 |
| CFEG | 0.48 | 780 | 25 |
| Cpoule | 0.38 | 6,800 | 18.5 |
| CB | 0.30 | 660 | 11 |
| CM | 0.29 | 180 | 10 |
| Tourbe | 0.2 | 2,110 | 12 |
| TA | 0.25 | >6,300* | — |

*The SOC plateau has not been reached with TA. The indicated SOC concentration corresponds to a Biosolid/Water ratio of 15 g per 70 ml of water.

### EXAMPLE 2

### Quantification of Soluble Phosphorus

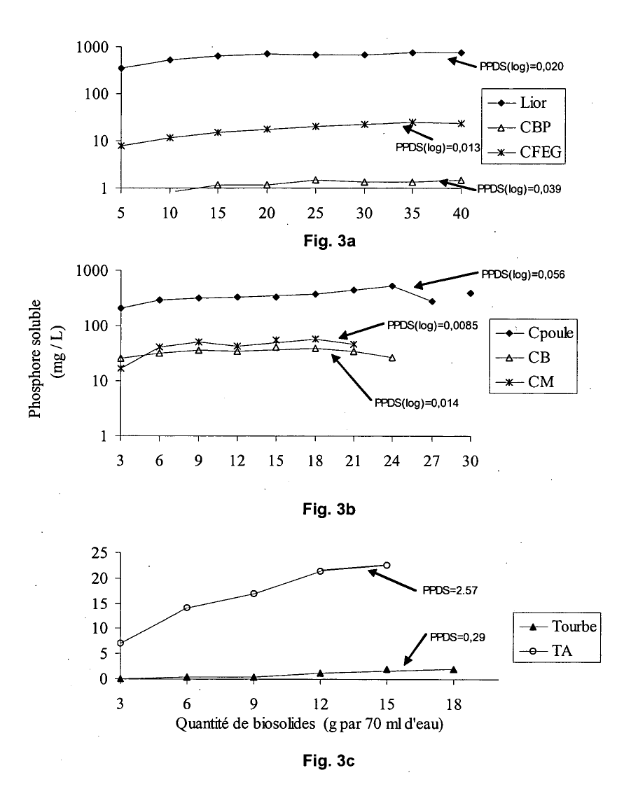

Soluble phosphorus quantification was determined as known in the art. Results illustrated on FIGS. 3a to 3c are expressed as concentration of soluble phosphrus (mg/L) as a function of the amount of organic matter (g per 70 mL of water). Table 5 shows that LIOR has the highest concentration in soluble P (590 mg/L), nearly 300-time more elevated than peat (2 mg/L). Therefore, LIOR is the most appropriate choice for the manufacture of an organo phosphatic mineral since it contributes to reduce the cost attributed to the phosphatic fertilizer portion of the pellet while maintaining a proper amount of phosphorus within the organo phosphatic fertilizer.

TABLE 5
Soluble phosphorus concentration at saturation.

| | | Soluble P | |
|---|---|---|---|
| | Density | concentration | Biosolid/Water ratio |
| Biosolid | (Mg m⁻³ ) | mg L⁻¹ | (g par 70 ml) |
| LIOR | 0.67 | 590 | 13.2 |
| CPPS | 0.52 | 1.2 | 15 |
| CLBG | 0.48 | 20.3 | 25 |
| CCM | 0.38 | 342 | 15.9 |
| CBM | 0.30 | 38 | 10.6 |
| CSM | 0.29 | 52 | 15 |
| Peat | 0.2 | 2.0 | 9.9 |
| AP | 0.25 | 18 | 15 |

### EXAMPLE 4

### Determination of Pig Manure Enrichment on Phosphorus Transformation in Acid-Light-Textured Soils

Materials and Methods

Soil and Manure Analyses

Four surface soil samples (0-20 cm) were collected from fluvio-glacial or deltaic deposits in St-Ubalde, Quebec, Canada (46° 43′ 57″ N, 74° 04′ 04″ W), where potato (Solanum tuberosum L.) and small grains are grown in rotation. Three humo-ferric podzols (Morin and Bevin sandy loams, Ivry loamy sand) were low in SOM (LSOM), and an Ivry peaty phase was high in organic matter content (HSOM).

Soil samples were collected in the potato phase. Soil samples were dried at 105° C. and passed through a 2-mm sieve. Soil pH was measured in 0.01 M. CaCl₂ using a 1:1 soil to solution ratio. Organic C was determined by the Walkley-Black procedure (Nelson and Sommers 1982). Soil texture was analyzed by the hydrometer method (Day 1965). The P and Al were extracted using the Mehlich-III procedure (Mehlich 1984). Phosphorus was determined colorimetrically (Laverty 1963), and Al by atomic absorption spectrophotometry (AAS) (Perkin Elmer 603 spectrophotometer, Perkin Elmer, Wellesley, Mass.). The 100(P/Al)_{M-III} weight ratio is a measure of soil P saturation for soil fertility classification and environmental risk assessment (Khiari et al. 2000). Soils with a 100(P/Al)_{M-III} weight ratio between 2 and 4% are considered to be of very low P fertility level (low P availability) and at very low P environmental risk (high P fixation) (Khiari et al. 2000).

The oxalate and pyrophosphate extractions were performed according to McKeague (1978). Soil samples were ground to <150 μm-sieved. The mixtures were 2.5-μm gravity-filtered (Whatman no. 42 paper), and the filtrate analyzed by plasma emission spectroscopy. The acid ammonium oxalate extracts organically bound, amorphous, and some crystalline forms of Al and Fe. The pyrophosphate extracts mainly organically bound, and only very small amounts of other forms of Al and Fe. The degree of phosphorus saturation (DPS) was computed as follows (Breeuwsma and Silva 1992):

$$DPS ( \% ) = \frac{100 {P}_{ox}}{{α}_{m} ( {Al}_{ox} + {Fe}_{ox} )} \qquad ( 1 )$$

where Pₒₓ, Alₒₓ and Feₒₓ are oxalate-extracted P, Al and Fe; DPS is the degree of phosphorus saturation expressed on a molar basis; αₘ, the maximum saturation factor for total sorption, is equal to approximately 0.66 across a wide variety of soils (Khiari et al. 2000). Lime addition as reagent-grade CaCO₃ was based on buffer pH (Shoemaker et al. 1961) to achieve a pH of 6.5 in the soil volume. The LIOR contained 368 g total C kg⁻¹, 26 g soluble C kg⁻¹, and 23.3 g total P kg⁻¹. Total C was determined by combustion (Leco CNS 2000). Soluble C was extracted in a saturated solution of 30 g LIOR in 70 ml of distilled water. The mixture was shaken for 24 h on an end-over-end shaker at 300 rpm, centrifuged at 12 000 rpm, then gravity-filtered through a Whatman no. 42 paper. Soluble C was digested according to Nelson and Sommers (1982). Total P was obtained after digesting LIOR in a HNO₃—HClO₄ mixture (Barnhisel and Bertsch 1982). Total phosphorus was quantified using the yellow method (Kuo 1996).
Sequential P Fractionation

The procedure for determining P pools and their designation are given in Table 6. The sequential fractionation of designated inorganic P (Pᵢ) pools was conducted using a modified Chang-Jackson procedure as described and designated by Kuo (1996). All extracts were 2.5-μm gravity-filtered (Whatman no. 42 paper). The loosely bound Pᵢ (LBP) was extracted using 1.0 M NH₄Cl, the P sorbed by Al (SP_{Al}) using 0.5 M NH₄F, the P sorbed by Fe (SP_{Fe}) using 0.1 M NaOH, the P sorbed by Ca (SP_{Ca}) using 0.25 M H₂SO₄, and the P sorbed as occluded or reductant Pᵢ (SP_{red}) using a citrate-dithionite-bicarbonate solution. All fractions except SP_{red} were determined according to (Kuo 1996), SP_{red} according to Peterson and Corey (1966).

Separate P Analyses

Total P was determined after digesting the soil (<2 mm) in a HNO₃—HClO₄ mixture (Barnhisel and Bertsch 1982). Soil organic P was quantified separately using a basic EDTA procedure (Bowman and Moir 1993) and 0.5 g soil samples. Samples were extracted for 2 h at 85° C. with 25 ml of 0.25 M NaOH+0.05 M Na₂EDTA. Organic P (P_{org}) in extracts was determined by persulfate oxidation. The P recovery was computed as the sum of inorganic and organic P fractions divided by total P. The P recovery (mean±standard deviation) was 97.1±3.7% across soils and treatments. The phosphorus was quantified using the yellow method (Kuo 1996). The desorbed P pool (DP) (Van der Zee et al. 1987) was determined in separate subsamples using 1:60 water to soil volume ratio (Sissingh 1971) and filtered (<2.5 μm, Whatman no. 42 paper). The P was quantified by the ascorbic acid blue method (Kuo 1996).

TABLE 6
Methodology for designated P pools

| P pool | Symbol | Extraction procedure or computation method | |
|---|---|---|---|
| | | Determined by extraction on the same sample | |
| Loosely bound P pool | LBP | 1 M NH₄Cl (Kuo, 1996) | |
| Al-sorbed P pool | SP_{Al} | 0.5 M NH₄F (Kuo, 1996) | |
| Fe-sorbed P pool | SP_{Fe} | 0.1 M NaOH (Kuo, 1996) | |
| Ca-sorbed P pool | SP_{Ca} | 0.25 M H₂SO₄ (Kuo, 1996) | |
| Reductant P pool | SP_{red} | Citrate-dithionite-bicarbonate (Kuo, 1996) | |
| | | Determined by extraction on separate samples | |
| Desorbed P Pool | DP | Sissingh (1971) and Van der Zee et al. (1987) | |
| Organically converted P | P_{org} | 0.05 Na₂EDTA + 0.25 NaOH (Bowman and Moir, 1993) | |
| | | Deduced by computation | |
| Sorbed inorganic P pool | SP_{inorg} | SP_{Al} + SP_{Fe} + SP_{Ca} + SP_{red} | (Eq. 6) |
| Reversible adsorbed P pool | APᵣₑᵥ | DP − LBP | (Eq. 5) |
| Sorbed P pool due to slow | SPₛᵣ | SP_{inorg} − APᵣₑᵥ | (Eq. 7) |
| reaction | | | |

Simulated P Diffusion Volume

The P diffusion coefficient from fertilizer is small in the range of 5 to 23.710⁷ cm² s⁻¹, depending on P rate, soil water content, and bulk density (BD) (Hira and Singh, 1978). Hira and Singh (1977) found that the P diffusion volume in soils increased with moisture content and BD, with maximum at 1.60 Mg m⁻³ followed by a drop toward 1.75 Mg m³. Moisture content was found to be 0.15-0.18 m³ m⁻³ in a Haibowal silty clay loam and 0.18-0.25 m³ m⁻³ in a Choa sandy loam for maximum ³⁶CI diffusion with BD of 1.25 Mg m⁻³ (Hira and Singh 1977, 1978). Riga and Charpentier (1998) showed that molecular diffusion coefficient depended on soil moisture content and BD. Similar coefficients were obtained for a fine sand (BD=1.68 Mg m⁻³) and a loam (BD=1.52 Mg m⁻³) with a volumetric water content of 0.25 m³ m⁻³, and for a peat-perlite mixture (BD=0.15 Mg m⁻³) with a volumetric water content close to 0.37 m³ m⁻³ (Riga and Charpentier, 1998). Our LSOM soils had BD values (scooped soil sample) between 1.17 and 1.36 Mg m³, compared to 0.78 Mg m⁻³ for the HSOM soil. Moisture contents were adjusted to 0.20-0.25 m³ m⁻³ in the LSOM soils, and to 0.37 m³ m⁻³ in the HSOM soil for facilitating molecular diffusion into the prescribed diffusion volume.

Dissolved P diffuses away from the granule across a soil volume of two to three times the diameter of the granule (James and Wells, 1990). The P distribution pattern from mono-ammonium phosphate (MAP) in an acid Hartsells fine sandy loam showed a P diffusion diameter of 38, 40 and 41 mm, respectively, around the application point after 4, 14 and 49 days (Giordano and Mortvedt, 1969). Should the diffusion volume be described by spheres of 20.5 mm of radius contacting each other along a continuous line and should the potato row spacing be 0.915 m, the total diffusion volume of two fertilizer bands about the potato seed would be about 19 m³ ha⁻¹. The simulated P diffusion volume was thus computed as follows:
V=(R³−r³)/r³ (2)
where V is the simulated diffusion volume (35 ml); R, the radius of the external limit of the P diffusion sphere after 6 wk of incubation, was set equal to 20.5 mm (Giordano and Mortvedt, 1969); r was set equal to R/3 (James and Wells 1990), giving a spherical volume of 1.35 ml. Thus, the selected granule to soil volume ratio was 1 to 26 (35/1.35).
Soil Treatments

Lime, manure, and fertilizers were applied into a constant soil volume. Treatments are described in Table 7. A volume of 1.35-ml (800 mg) of LIOR was added to a 35-ml soil sample, i.e. 26 times LIOR volume, to provide 23 g LIOR L⁻¹ of soil (=800 mg of LIOR per 35 ml of soil) or 14.6 g L⁻¹ of soil as organic matter (OM). Added OM was 21 g kg⁻¹ for the Morin SL, 22 g kg⁻¹ for the Bevin SL, 19 g kg⁻¹ for the Ivry LS, and 32 g kg⁻¹ for the Ivry LS, peaty phase, due to differences in BD. Adding up exogenous and indigenous OM percentages, OM contents were 61 g kg⁻¹ in the Morin SL, 71 g kg⁻¹ in the Bevin SL, 59 g kg⁻¹ in the Ivry LS, and 232 g kg⁻¹ in the Ivry LS peaty phase, respectively. The Morin and Bevin soils received 276 mg of CaCO₃ per 35 ml of soil, the Ivry soil 185 mg, and the Ivry peaty phase, 369 mg. Added P as MAP-[reagent-grade mono-ammonium phosphate: NH₄H₂PO₄] and LIOR-P was 0, 49, 127, or 265 mg P per 35 ml of soil. Added P divided by the weight of the MAP-LIOR mixture were 0 (zero-P control), 5, 10, and 15%. Due to variations in BD, the P added into a 20.5-mm radius fertilizer band was, on a weight basis for 265 mg P per 35 ml of soil, as follows: 6360 mg P kg⁻¹ for the Morin SL, 6470 mg P kg⁻¹ for the Bevin SL, 5570 mg P kg⁻¹ for the Ivry LS, and 9706 mg P kg⁻¹ for the Ivry LS peaty phase. Application rates would be respectively 0, 27, 69 and 144 kg P ha⁻¹, the lower rates being commonly applied to potato (Solanum tuberosum L.) grown in high-fertility soils, and the intermediate rate being applied in medium-fertility soils (Khiari et al. 2000). The potato could respond to the highest P rate in high-P fixing soils. There was no pre-incubation of soils and treatments, which were intended to modify soil properties in the fertilizer band. Prior to the experiment, dry samples of 35 ml of soil were mixed with MAP, lime or LIOR in 250-ml polypropylene recipients. The four soils, maintained at field capacity with distilled water, were incubated in duplicates at 23±2° C. for six wk to allow slow reactions to occur.

TABLE 7
Treatments applied to the incubated soils (MAP = mono-ammonium
phosphate, and LIOR = dry swine manure)

| | Treatment | MAP | | Total P |
|---|---|---|---|---|
| Ligand | identification | weight | MAP + LIOR weight^{z} | as MAP |
| | | mg of product in 35 ml of soil | | |
| LIOR | 0 P | 0 | 800 | 0 |
| (800 mg | 5 P | 184 | 984 | 49 |
| per 35 ml | 10 P | 470 | 1270 | 127 |
| of soils) | 15 p | 980 | 1780 | 265 |
| CaCO₃ | 0 P | 0 | 0 | 0 |
| (185-369 mg | 5 P | 184 | 184 | 49 |
| per 35 ml of | 10 P | 470 | 470 | 127 |
| soils) | 15 P | 980 | 980 | 265 |
| Non-amended | 0 P | 0 | 0 | 0 |
| control | 5 P | 184 | 184 | 49 |
| | 10 P | 470 | 470 | 127 |
| | 15 P | 980 | 980 | 265 |

^{z}Total weight of fertilizer granule = weight of MAP + LIOR, LIOR = 800 mg for the LIOR treatment and LIOR = 0 for others

Fertilizer Phosphorus Accumulation in Soil P Pools

Net P acquisition in a given P pool was made on a volume basis (mg L⁻¹). A unitless rate of P acquisition per unit of added P was computed for the prescribed diffusion volume. Differential increase in P pool Δ(P) as net P acquisition in mg P L⁻¹ was computed by difference Δ(P)_{F} between P pools in MAP-fertilized (P_{F}) and zero-P control (P_{C}) treatments, as follows:
Δ(P)=P_{F}−P_{C} (3)

We computed Δ(LBP) Δ(SP_{Al}), Δ(SP_{Fe}) Δ(SP_{red}), Δ(SP_{Ca}), Δ(DP), and Δ(P_{org}). Proportions r(P)_{F} in a given pool relative to added P (mg P L⁻¹) was computed as follows:

$${r ( P )}_{F} ( \% ) = \frac{{Δ ( P )}_{F}}{Added P} \times 100 \qquad ( 4 )$$

The r(P)_{F} was the slope of the relationship between Δ(P) and added P, computed similarly to the increase in anion exchange P pool in response to added P (Jones et al., 1984). Loosely bound P, designated as LBP (NH₄Cl-extracted), is a fraction of desorbed P. Difference between desorbed P and LBP was designated as reversibly adsorbed P(r(APᵣₑᵥ)_{F}) computed as follows:
r(APᵣₑᵥ)_{F}=r(DP)_{F}−r(LBP)_{F} (5)
where r(APᵣₑᵥ)_{F}, r(DP)_{F}, r(LBP)_{F} are proportions of reversibly adsorbed RP, desorbed RP (Sissingh 1971), and loosely bound RP pools, respectively. Proportions of sorbed inorganic P pools were summed up as r(SP_{inorg})_{F} as follows:
r(SP_{inorg})_{F}=r(SP_{Al})_{F}+r(SP_{Fe})_{F}+r(SP_{red})_{F}+r(SP_{Ca})_{F} (6)

Sorbed P due to slow reactions (Van der Zee et al., 1987), i.e. r(SPₛᵣ)_{F}, was computed by difference between sorbed inorganic P (Eq. 6), and reversibly adsorbed P (Eq. 5) as follows:
r(SPₛᵣ)_{F}=r(SP_{inorg})_{F}−r(APᵣₑᵥ)_{F} (7)

The sum of all P pools from added P was computed as follows:
r(Pₜₒₜₐₗ)_{F}=r(SP_{inorg})_{F}+r(P_{org})_{F}+r(LBP)_{F} (8)

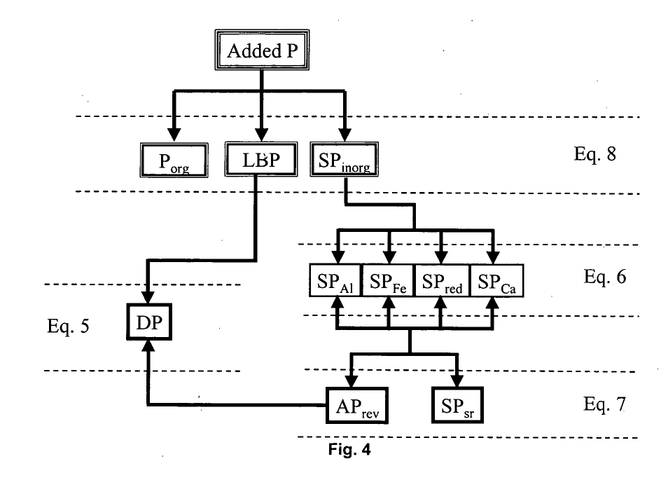

See the flowchart of P pools presented in FIG. 4.

Statistical Analyses

The experimental setup was a factorially arranged randomized complete block design with two replications. We used the GLM procedure for data analysis (SAS, 1990). Soil type and ligand sources (LIOR or lime) were considered as categorical variables, while the P application rates were analysed as continuous variables. Significance of differences between means was assessed using orthogonal contrasts. Regression analyses on the effects of P application rates Were conducted using the Excel package (Microsoft, 1997) and the REG procedure (SAS, 1990).

Results

Partitioning of Added P among Phosphorus Fractions in Fertilized Soils

Soil characteristics and P fractions are presented in Table 8. The SP_{Al} accounted for 37 to 43% of total P in LSOM soils, compared to 9% in the HSOM soil. The SP_{Fe} fraction ranked second. Soil types, P rates, and amendments (LIOR, lime) significantly influenced the partition of added P (Table 9). The P rate and contrast between LSOM and HSOM soils gave highest F values. There were significant treatment interactions for Δ(LBP), Δ(SP_{Al}), Δ(SP_{Fe}), Δ(DP), and Δ(P_{org}). Linear and quadratic effects of P doses depended on soils and amendments. Barrow (1983) and Van der Zee et al. (1987) also found that P sorption decreased quadratically with added P. The contrasts were significant between sandy loams (Morin, Bevin) on the one hand, and between sandy loams and the loamy sand (Ivry), on the other. There was no significant effect of lime compared to control across P fractions, except for Δ(DP) and Δ(P_{org}). We thus contrasted LIOR with (control+lime). The Δ(DP) pool was much larger than the Δ(LBP) (Table 10). Similarly to 1 M KCl, the 1 M NH₄Cl solution extracts exchangeable and some non-isotopically exchangeable Al³⁺ (Kotze et al., 1984). Presumably, some NH₄Cl-exchangeable Al³⁺ reacted with ortho-phosphate to form aluminium phosphates, that lowered the Δ(LBP) pool and was recoverable as ×(DP). The r(P)_{F} for the highest P treatment are presented in Table 10 for the soil times amendment interaction. Similarly to findings by Sharpley and Smith (1983), 79 to 92% of added P was sorbed as SP_{inorg} across treatments in LSOM soils. Comparatively, 51 to 61% of added P was sorbed as SP_{inorg} in the HSOM soil. The r(LBP)_{F} pool was abundant in the HSOM soil only.

TABLE 8
Properties of the acid soils under study

| | | Soil Series | | | |
|---|---|---|---|---|---|
| Property | | Morin | Bevin | Ivry | Ivry peaty phase |
| Texture | | Sandy loam | Sandy loam | Loamy sand | Loamy sand |
| | | g kg⁻¹ | | | |
| Organic matter content | | 40 | 49 | 40 | 200 |
| Clay | | 65 | 65 | 56 | 48 |
| Sand | | 723 | 524 | 876 | 734 |
| | | Unitless | | | |
| pH (CaCl₂) | | 4.8 | 4.3 | 5.2 | 3.7 |
| SMP buffer pH | | 5.6 | 5.6 | 6.0 | 5.2 |
| | | Mg m⁻³ | | | |
| Bulk density | | 1.19 | 1.17 | 1.36 | 0.78 |
| | | mg kg⁻¹ | | | |
| Pₜₒₜₐₗ | | 2440 | 2645 | 1170 | 407 |
| | LBP | 0 | 0 | 0 | 5 |
| | SP_{Al} | 1048 | 1126 | 431 | 37 |
| P Fractionation^{z} | SP_{Fe} | 545 | 655 | 159 | 18 |
| | SP_{red}^{y} | 80 | 107 | 21 | 18 |
| | SP_{ca} | 248 | 215 | 275 | 4 |

| Al extracted by NH₄F | 3591 | 5781 | 1056 | 397 |
|---|---|---|---|---|
| Fe extracted by NaOH | 244 | 162 | 153 | 700 |
| P_{M-III}^{x} | 75.5 | 81.7 | 49.1 | 45.3 |
| Al_{M-III}^{x} | 1888 | 1945 | 2046 | 1510 |
| Fe_{M-III}^{x} | 206 | 191 | 144 | 658 |
| | mmol kg⁻¹ | | | |
| Pₒₓ^{w} | 62.2 | 71.7 | 35.9 | 14.1 |
| Alₒₓ^{w} | 404.4 | 474.1 | 351.1 | 129.5 |
| Feₒₓ^{w} | 167.1 | 182.9 | 107.9 | 109.3 |
| Alₒₓ + Feₒₓ | 571.5 | 657.0 | 459.0 | 238.8 |
| | % | | | |
| DPS (%)^{v} | 16.5 | 16.5 | 11.8 | 8.9 |
| 100(P/Al)_{M-III}^{u} (%) | 4.0 | 4.2 | 2.4 | 3.0 |

^{z}Differential P dissolution technique of Kuo (1996)
^{y}Extracted by citrate-dithionite-bicarbonate
^{x}Extracted using the Mehlich-III procedure (Mehlich, 1984)
^{w}Oxalate extraction according to McKeague (1978)
^{v}Degree of Phosphorus Saturation as defined by Breeuwsma and Silva (1992)
^{u}P saturation as defined by Khiari et al. (2000)

TABLE 9
Effects of soil (LSOM = low soil organic matter; HSOM = high soil organic
matter; SL = sandy loam; LS = loamy sand)), amendment (LIOR = dry swine
manure), and P doses on P pools

| | | P pool | | | | |
|---|---|---|---|---|---|---|
| | | Loosely | | | | Desorbed |
| | | bound P | Sorbed P | | | P |
| | | Δ(LBP)^{y} | Δ(SP_{Al})^{y} | Δ(SP_{fe})^{y} | Δ(P_{org})^{y} | Δ(DP)^{y} |
| Source | Df^{z} | F value | | | | |
| Soil | 3 | 1156.56** | 971.01** | 300.20* | 440.32** | 450.41** |
| Amendment | 2 | 27.76** | 22.32** | 0.36 ns | 121.99** | 16.58** |
| Dose P | 2 | 2091.97** | 10066.54** | 721.77** | 791.51** | 2140.08** |
| Soil * Amendment | 6 | 10.30** | 1.05 ns | 8.73** | 12.11** | 7.05** |
| Soil * dose P | 6 | 580.70** | 261.30** | 29.41** | 81.30** | 248.05** |
| Amendment * dose P | 4 | 17.18** | 9.76** | 0.30 ns | 38.13** | 6.89** |
| Soil * Amendment * dose P | 12 | 8.67** | 1.81 ns | 1.30 ns | 6.59** | 4.75** |

Contrast

| | | | | | | |
|---|---|---|---|---|---|---|
| LSOM vs HSOM | 1 | 3456.56** | 2911.05** | 782.38** | 1269.43** | 1332.05** |
| LSOM (SL vs LS) | 1 | 7.81** | 1.48 ns | 104.24** | 48.32** | 14.97** |
| Morin vs Bevin | 1 | 5.31* | 0.52 ns | 13.97** | 3.32 ns | 4.20* |
| control vs Lime | 1 | 1.98 ns | 1.68 ns | 0.59 ns | 36.59** | 20.80** |
| (control + Lime) vs LIOR | 1 | 53.54** | 42.97** | 0.13 ns | 207.40** | 12.35** |

Polynomial contrast

| | | | | | | |
|---|---|---|---|---|---|---|
| Linear (P rates) | 1 | 4073.03** | 20113.76** | 1432.97** | 1570.02** | 4174.53** |
| Quadratic (P rates) | 1 | 112.12** | 18.21** | 10.35** | 12.75** | 106.83** |
| Root of error mean of squares | | 45.32 | 98.20 | 53.90 | 25.00 | 131.32 |
| Coefficient of variation | | 12.7% | 3.3% | 10.7% | 13.5% | 12.4% |
| R-Square | | 0.99 | 0.99 | 0.99 | 0.99 | 0.99 |

^{z}df: degree of freedom
ns, *, **: non significant and significant at the 0.05 and the 0.01 levels, respectively
^{y}Fertilizer phosphorus accumulation in soil P pool (Eq.[3])

TABLE 10
Effects of soil (LSOM = low soil organic matter; HSOM = high soil organic
matter; SL = sandy loam; LS = loamy sand)), amendment (LIOR = dry swine
manure), and P doses on proportions of added P in soil P pools for the highest P treatment

| P pool | | |
|---|---|---|
| Loosely | | Desorbed |
| bound P | Sorbed P | P |

| | | r(LBP)^{y}_{F} | r(SP_{Al})_{F}^{y} | r(SP_{Fe})_{F}^{y} | r(P_{org})_{F}^{y} | r(DP)_{F}^{x} |
|---|---|---|---|---|---|---|
| Source | Df^{z} | F value | | | | |
| Soil | 3 | 758.87** | 669.48** | 90.48** | 176.88** | 330.95** |
| Amendment | 2 | 20.98** | 19.41** | 0.14 ns | 66.65** | 10.36** |
| Soil * Amendment | 6 | 9.43** | 157 ns | 2.23 ns | 6.95** | 5.82** |

Contrast

| | | | | | | |
|---|---|---|---|---|---|---|
| LSOM vs HSOM | 1 | 2270.04** | 2004.64** | 240.05** | 501.44** | 978.64** |
| LSOM (SL vs LS) | 1 | 3.02 ns | 1.11 ns | 31.30** | 29.11** | 11.26** |
| Morin vs Bevin | 1 | 3.56 ns | 2.68 ns | 0.09 ns | 0.08 ns | 2.95** |
| No ligand vs Lime | 1 | 1.23 ns | 2.68 ns | 0.02 ns | 20.09** | 13.03** |
| (No ligand + Lime) vs LIOR | 1 | 40.73** | 36.14** | 0.26 ns | 113.20** | 7.68** |
| Root of error mean of squares | | 1.03 | 1.81 | 1.16 | 0.53 | 2.89 |
| Coefficient of variation | | 9.26% | 2.67% | 10.8% | 12.0% | 8.88% |
| R-Square | | 0.99 | 0.99 | 0.96 | 0.98 | 0.99 |

Average r(P)_{f} across treatments

| Soil | Amendment | r(LBP)_{F} | r(SP_{Al})_{F} | r(SP_{Fe})_{F} | r(P_{org})_{F} | (Total)^{w} | r(DP)_{F} | r(SPᵣₑᵥ)_{F}^{v} | r(SP_{inorg})_{F}^{u} | r(SPᵢᵣᵣ)_{F}^{t} |
|---|---|---|---|---|---|---|---|---|---|---|
| | | % | | | | | | | | |
| Morin | Control | 4.9 | 78.8 | 9.6 | 1.8 | 95.1 | 22.0 | 17.1 | 88.4 | 71.3 |
| | LIOR | 6.1 | 74.3 | 10.0 | 4.1 | 94.5 | 22.6 | 16.5 | 84.3 | 67.8 |
| | Lime | 5.8 | 76.7 | 9.3 | 1.9 | 93.7 | 20.5 | 14.7 | 86.1 | 71.3 |
| Bevin | Control | 4.3 | 78.3 | 8.4 | 2.0 | 93.0 | 18.9 | 14.6 | 86.7 | 72.1 |
| | LIOR | 4.5 | 76.0 | 10.0 | 3.8 | 94.4 | 20.0 | 15.4 | 86.0 | 70.6 |
| | Lime | 4.5 | 80.7 | 11.1 | 1.7 | 98.0 | 17.6 | 13.1 | 91.8 | 78.7 |
| Ivry | Control | 5.3 | 80.5 | 6.5 | 2.4 | 94.7 | 25.4 | 20.2 | 87.0 | 66.8 |
| | LIOR | 7.2 | 72.7 | 6.2 | 5.0 | 91.1 | 25.2 | 17.9 | 78.9 | 60.9 |
| | Lime | 5.2 | 76.4 | 6.7 | 4.6 | 93.0 | 24.7 | 19.5 | 83.2 | 63.7 |
| Ivry PP | Control | 24.9 | 42.2 | 19.0 | 6.0 | 92.0 | 69.6 | 44.6 | 61.1 | 16.5 |
| | LIOR | 34.0 | 35.0 | 16.2 | 11.4 | 96.6 | 71.7 | 37.7 | 51.2 | 13.5 |
| | Lime | 26.1 | 40.0 | 15.4 | 8.6 | 90.1 | 52.3 | 26.1 | 55.3 | 29.2 |

^{z}df: degree of freedom
ns, *, **: non significant and significant at the 0.05 and the 0.01 levels, respectively
^{y}P proportion of added P in soil P pools (Eq.[4])
^{x}P proportion of added P as desorbed P
^{w}Sum of r(LBP)_{F}, r(SP_{Al})_{F}, r(SP_{Fe})_{F}, and r(P_{org})_{F}
^{v}P proportion of added P as reversibly bound P (Eq.[5])
^{u}P proportion of added P as sorbed inorganic P (Eq.[6])
^{t}P proportion of added P as P sorbed by slow reactions (Eq.[7])

Loosely Bound Phosphorus Pool (LBP)

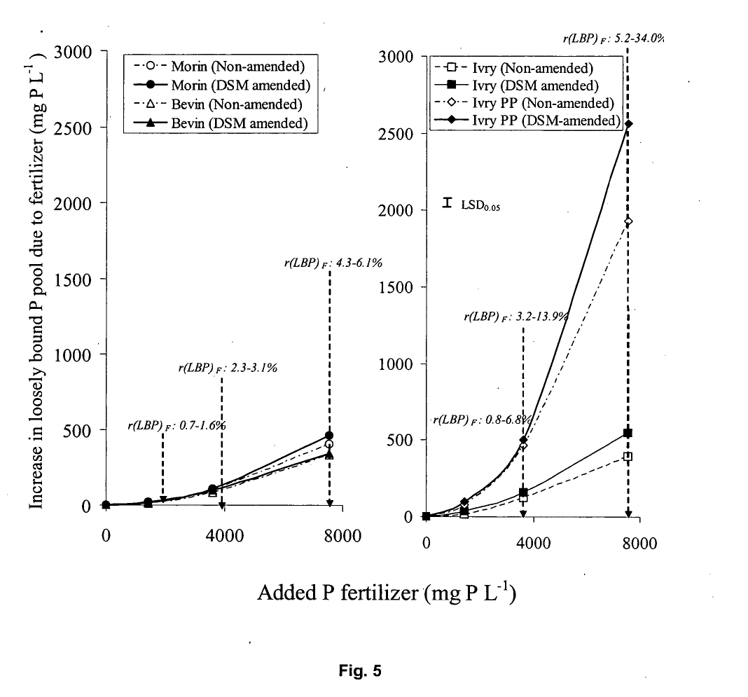

The Δ(LBP) depended on soil type and amendment (Table 9). Only 0.7 to 6.1% of added P was converted to LBP in LSOM soils, compared to 34% in the LIOR-treated HSOM soil (FIG. 5). The Δ(LBP) increased nearly 5 times as SOM increased from 4 to 20% (Table 8). The P fixation capacity was 2.4 times larger in LSOM soils [i.e. 0.66 times 562.5 mmol (Feₒₓ+Alₒₓ) kg⁻¹)] than in the HSOM soil [i.e. 0.66 times 238.8 mmol (Feₒₓ+Alₒₓ) kg⁻¹)], although DPS was low across soils (Table 8). Lower pH in the HSOM than in LSOM soils was expected to promote P fixation and thus decrease Δ(LBP) for comparable DPS values. However, ligand exchange reactions in the HSOM soil presumably protected added P by forming stable OM-metal complexes (Fox et al., 1990). Indeed, the pyrophosphate extraction accounted for 24.5% of the oxalate-extracted Al and Fe in the HSOM, compared to 16.5-21.3% in LSOM soils (Table 11). The LIOR increased pyrophasphate-extracted Al and Fe by 2.7% in the HSOM soil, and produced a significant effect only in the Ivry soil among LSOM soils (Table 11). The HSOM was by far the most responsive to LIOR in producing organically-bound Al and Fe (Table 11) and converting added P into LBP (FIG. 5). The DPS based on oxalate extraction alone (thus including the pyrophosphate extraction) should be interpreted with caution in connection with environmental protection and as a soil P availability index for crops, considering the apparent differential reactivity of amorphous and organically bound Al and Fe toward P.

Highest-level interaction and the (control+lime) vs LIOR contrast were significant for Δ(LBP) (Table 9), due to a significant LIOR effect in the HSOM soil at the highest P rate. The r(LBP)_{F} (Eq. 4) in the HSOM soil averaged nearly 25% across control and lime treatments, and 34% with LIOR. (Table 10). In LSOM soils, LIOR showed no significant effect compared to (control+lime) for the Bevin soil, but a slight contribution to LBP of less than 2% in the Morin and the Ivry soils (FIG. 5). Higher amounts of LIOR than used in this study should likely be added to increase the organic amendment effect in those LSOM high P-fixing soils.

Phosphorus Sorbed by Aluminium (SP_{Al}) and Iron (SP_{Fe})

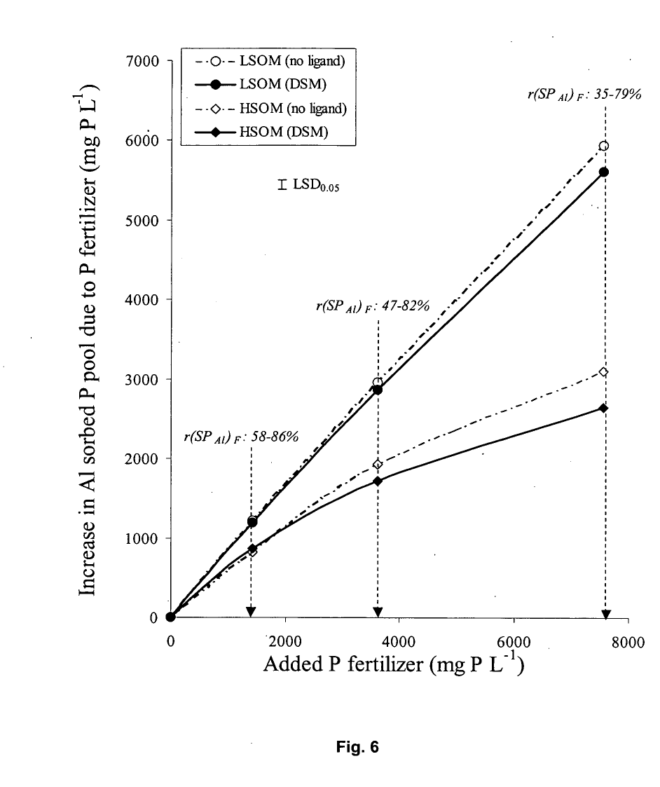

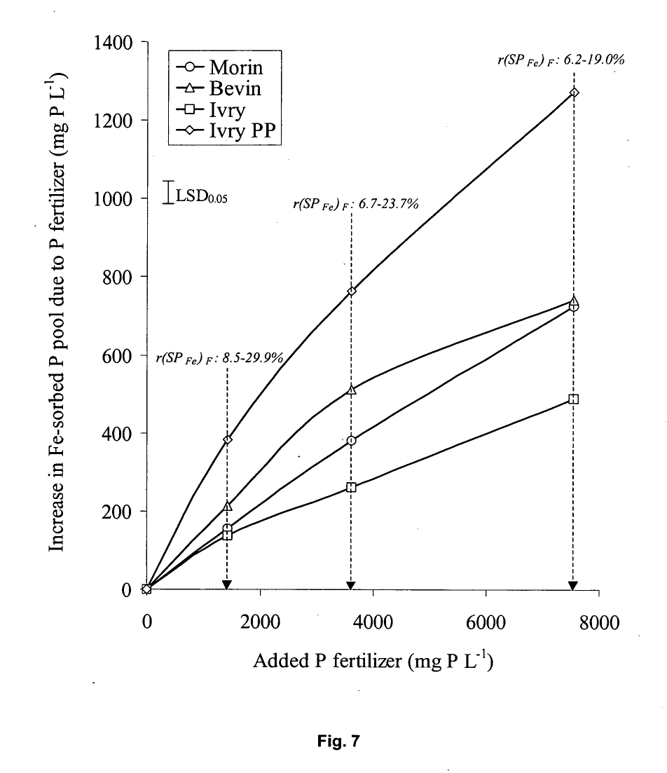

In LSOM soils, added P accumulated mainly as SP_{Al}, reported to be more available to plants than SP_{Fe} (Anthony and Ellis, 1968). The (control vs lime) and [(control+lime) vs LIOR] contrasts were not significant for Δ(SP_{Fe}) (Table 9). The r(SP_{Al})_{F} accounted for 79-86% of added P in LSOM soils, and for 35-58% in the HSOM soil (FIG. 6). The (control+lime) vs LIOR contrast was significant for Δ(SP_{Al}) (Table 9). The LIOR decreased the proportions of SP_{Al} (FIG. 6). The Δ(SP_{Al}) increased with added P (P<0.01) (FIG. 6 and Table 9) and was largest in LSOM soils. The r(SP_{Fe})_{F} proportions were <11% for LSOM soils and 19-30% for the HSOM soil (FIG. 7).

Organic Phosphorus (P_{org})_{F}

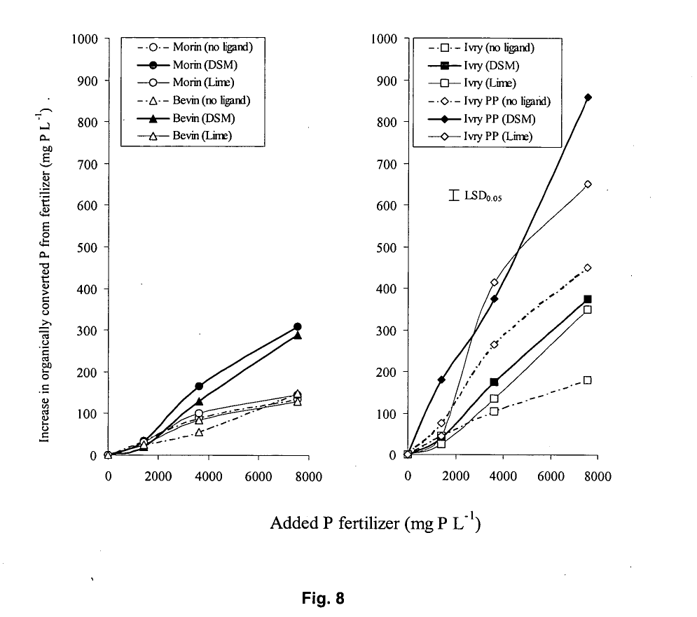

The organic P turnover in soils is mediated by microbial activity and C dynamics (Huffman et al., 1996). In the highest P treatment, Δ(P_{org}) increased with increasing organic C from 135-180 mg L⁻¹ in control or limed LSOM soils, to 290-375 mg L⁻¹ in LIOR-treated LSOM soils, 450-650 mg L⁻¹ in control or limed HSOM, and 860 mg L⁻¹ in LIOR-treated HSOM soils (FIG. 8). The higher the OM content, the larger was Δ(P_{org}), as also found by Sharpley et al. (1989). The (control vs lime) and [(control+lime) vs LIOR] contrasts were significant (Table 9). The higher the added P, the larger was the difference between treatments for r(P_{org})_{F} (FIG. 8). For the highest P treatment in LSOM soils, r(P_{org})_{F} was 1.8-2.4% for control, 1.7-4.6% for lime, and 3.8-5.0% for LIOR. In the HSOM soil, r(P_{org})_{F} was 6.0% for control, 8.6% for lime, and 11.5% for LIOR (Table 10). Thus, some added P was converted into organic P in presence of lime or LIOR.

Desorbed Phosphorus Pool (DP)

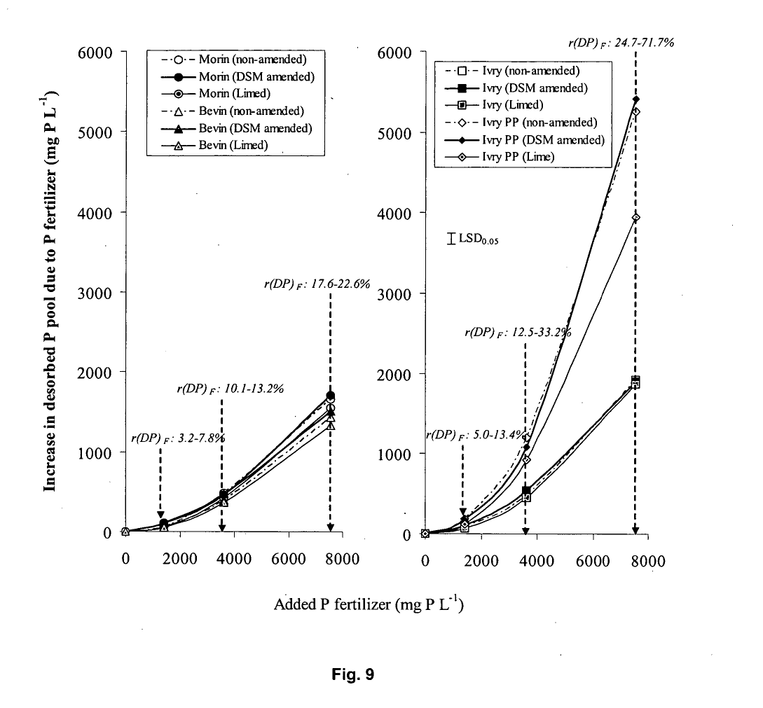

The Δ(DP) increased abruptly with added P (FIG. 9). For the 5 P, 10 P, and 15 P treatments, respectively, r(DP)_{F} increased from 3.2-7.8% to 10.1-13.2% and 17.6-22.6% in LSOM soils, and from 8.6-13.4% to 25.5-33.2% and 52.3-71.7% in the HSOM soil, respectively (FIG. 9). Comparatively, anion exchange resin P fractions ranged between 6% in high-P fixing soils and 74% in soils of low P sorption capacity across slightly to highly weathered soils of continental USA and Puerto Rico (Sharpley et al., 1984). The highest P treatment was the only one producing significant differences among control, lime, and LIOR treatments (FIG. 9). The r(DP)_{F} averaged 21.5% in LSOM and 69.6% in HSOM soils. In the latter case, r(DP)_{F} was 52.3% for the lime and 71.7% for the LIOR treatments. The organic ligands in LIOR presumably produced P desorption. The lime may increase or decrease P solubility depending on formation of new highly active polymeric hydroxy-Al, precipitation as insoluble Ca phosphates, or stimulation of microbial activities (Haynes 1982). In our case, microbial P immobilization rather than P sorption apparently decreased Δ(DP) by increasing Δ(P_{org}) (FIG. 8).

Sorbed Phosphorus Pools

For the highest P treatment, r(SP_{inorg})_{F} was found to be 78.9-88.4% for LSOM soils and 51.2-61.1% for the HSOM soil (Table 10). The r(APᵣₑᵥ)_{F} averaged 16.5% in LSOM soils, and 36% in HSOM soil (Table 10). The r(SPₛᵣ)_{F} accounted for 13.5% of the total sorbed Pᵢ (r(SP_{inorg})_{F}) in the HSOM soil receiving LIOR compared to 61-79% for LSOM soils (Table 10).

The Phosphorus Partitioning in SOM Soil Groups

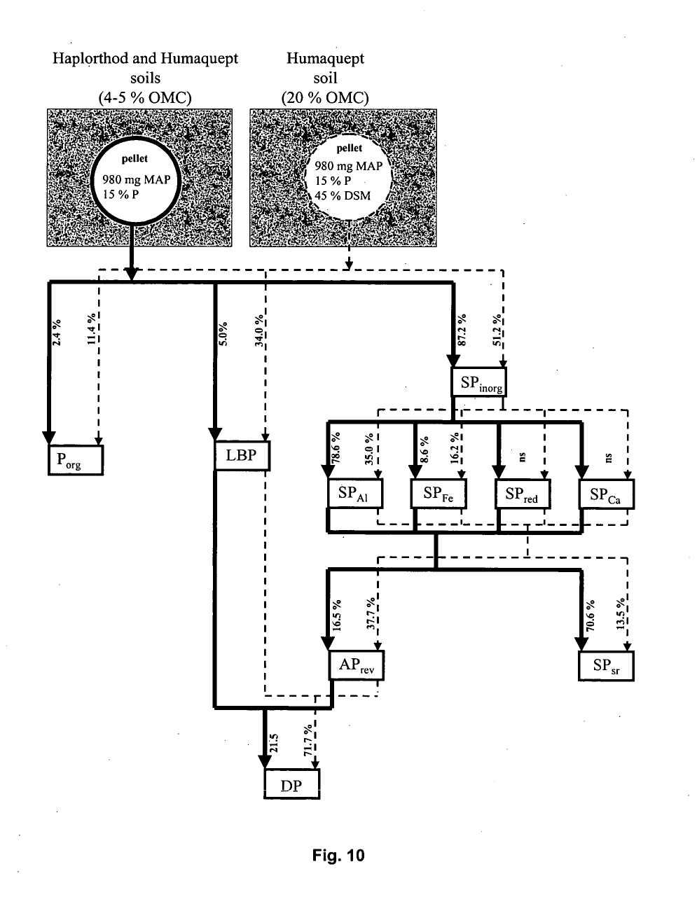

The flowchart in FIG. 10 illustrates the P pools for the highest P treatment in LSOM and HSOM soils receiving LIOR, as SOM was the single most determinant factor in reducing P retention in these soils. The r(LBP)_{F} increased nearly 7 times from 5.0% in LSOM control soils to 34.0% in the HSOM soil receiving LIOR (FIG. 10), as total SOM increased about 3.3 times from 71 to 232 g kg⁻¹. The r(DP)_{F} increased 3.3 times from 21.5% in LSOM control soils to 71.7% in the HSOM soil receiving LIOR (FIG. 10). Conversely, r(SPₛᵣ)_{F} decreased from 70.6% in LSOM control soils to 13.5% in the HSOM soil receiving LIOR. Added P was retained mainly as SP_{Al}, but P sorption varied among soils. The r(SPA)_{F} was 78.6% in LSOM soils without LIOR and 35.0% for the HSOM soil receiving LIOR (FIG. 7). Therefore, combining inorganic P and LIOR could improve P fertilizer efficiency in these high-P fixing soils. Since the effect of organic residues on P binding and desorption must depend not only on P but also on soil type (Olsen and Barber 1986), field trials are needed to ascertain the right proportions of LIOR and MAP maintaining maximum LBP in the fertilizer band during the potato growing season.

Results show that native (SOM) or supplemented (LIOR) sources of organic matter alleviated P fixation in podzolic soils, and modified the partition of added phosphate fertilizer (MAP) in favor of less tightly bound P pools. The LIOR appeared inefficient when applied at a rate of 23 g L⁻¹ of soil to increase SOM by 14.6 g L⁻¹ in soils already containing 40 to 50 mg SOM kg⁻¹. A comparative soil containing 200 mg SOM kg⁻¹ and receiving similar amounts of LIOR in the same soil volume reduced the P fixation by Al from 78.6 to 35.0%, and increased loosely bound P from 5.0 to 34.0%. Since most acid mineral soils contain less than 50 g OM kg⁻¹, LIOR may improve fertilizer P efficiency in the fertilizer band of acid soils, thus potentially reducing P application rates for the potato production. A more detailed study is required to select the optimum organo-mineral combinations for improving P efficiency in the fertilizer band in relation with amorphous and organically bound Al and Fe in acid light-textured soils used for the potato production. The P partitioning flowchart based on P fractionation indicated the major role of OM in reducing the P binding energy in those highly P-fixing soils.

TABLE 11
Effect of soil type and dry swine manure (LIOR) addition on Al- and
Fe- extracted pyrophosphate for the highest P treatment

| | | Means | | | |
|---|---|---|---|---|---|
| | | Pyrophosphate extraction (mmol kg⁻1) | | | |
| Soil | Treatment | Al_{pyr}^{y} | Fe_{pyr}^{y} | (Al + Fe)_{pyr} | $\frac{{( Al + Fe )}_{pyr}}{{( Al + Fe )}_{ox}} \times 100$ |
| Morin | No LIOR | 80.0 | 32.1 | 112.1 | 19.6 |
| | LIOR | 81.5 | 32.1 | 113.6 | 19.9 |
| Bevin | No LIOR | 98.5 | 41.4 | 139.9 | 21.3 |
| | LIOR | 106.7 | 43.2 | 149.9 | 20.7 |
| Ivry | No LIOR | 55.6 | 20.0 | 75.6 | 16.5 |
| | LIOR | 78.5 | 20.7 | 99.2 | 18.0 |
| Ivry | No LIOR | 35.6 | 22.9 | 58.4 | 24.5 |
| peaty | LIOR | 39.3 | 25.7 | 65.0 | 27.2 |
| phase | | | | | |

| Soil | Df^{z} | F value | | | |
|---|---|---|---|---|---|
| Soil | 3 | 195.59** | 906.54** | 285.16** | 97.96** |
| LIOR | 1 | 21.63** | 17.31** | 24.43** | 7.52* |
| LIOR × | 3 | 6.14* | 3.77 ns | 5.08* | 3.98* |
| Soil | | | | | |
| Root of error | | 3.907 | 0.64 | 4.21 | 0.73 |
| mean of squares | | | | | |
| Coefficient of | | 5.4% | 2.2% | 4.1% | 3.5% |
| variation | | | | | |
| R-Square | | 0.99 | 0.99 | 0.99 | 0.98 |

^{z}Df: degree of freedom
ns, *, **: non significant and significant at the 0.05 and the 0.01 levels, respectively
^{y}McKeague (1978).

### EXAMPLE 5

### Determination of the Effect of the Composition of A Lior-Based OMF on Corn Growth

To determine the effect of different combinations of biosolids and mineral fertilizers on the growth of corn, bio-treated manure was mixed to mineral fertilizers rich in N (32-0-0), P (8-25-3) or K(6-0-30), in different proportions. The parameters of the experimentation are described in Table 12 and Table 13.

TABLE 12
2001 characteristics of corn cultivated soils, corn cultural parameters and
sample dates

| Sites | 1 | 2 | 3 |
|---|---|---|---|
| Town or landlord | St- | St-Francois | Montmagny |
| | Madeleine | | |
| Producer | Francis | Clément Lamonde | J. Yves Gosselin |
| | Dion | | |
| Cultivar | Pioneer | Dkc27-11 | Semico h12093 |
| | 38J54 | | |
| UTM | 2800 | 2250 | 2300 |
| Sowing date | May 3 | May 18 | May 19 |
| Harvesting date | October 4 | October 18 | October 18 |
| Plantlet sample date | June 15 | June 27 | June 27 |
| Foliar sample date | August 2 | August 8 | |
| Soil sample date | May 25 | October 18 | October 18 |
| Soil series | Richelieu | St-Épiphane | Kamouraska |
| Texture | Loam | Sandy loam | Slimy clay |
| Clay (%) | 21.4 | 9.7 | 46.6 |
| MO (%) | 2.8 | 3.2 | 9.2 |
| pH (0.01 M CaCl₂) | 5.94 | 5.53 | 6.04 |
| P_{M-III}(mg/kg) | 95.8 | 48.4 | 89.9 |
| Al_{M-III}(mg/kg) | 790.8 | 426.2 | 1012.2 |
| 100(P/A1)_{M-III}(%) | 12.1 | 11.4 | 8.9 |

Results

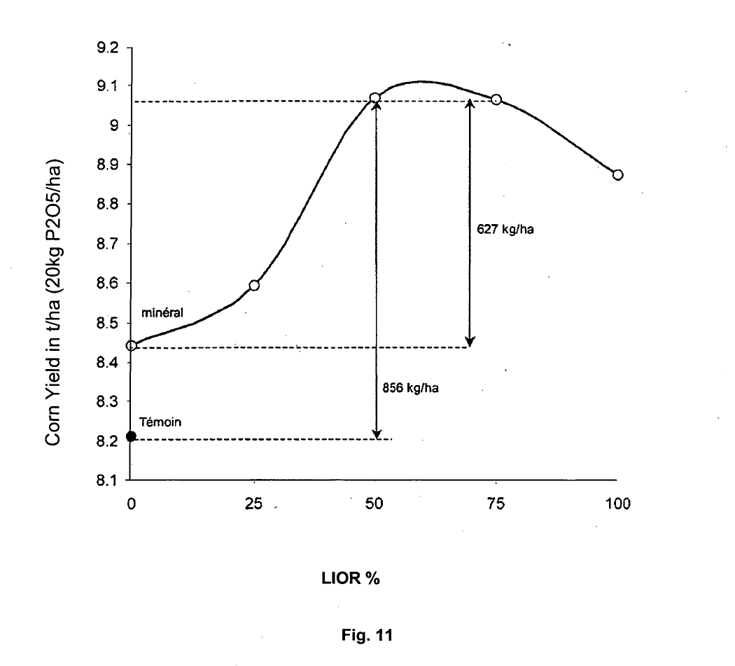

The effect of the different combinations of organo phosphatic fertilizer is shown in Table 14 and FIG. 11. Results show that 50 and 75% LIOR increases the yield of corn crops by 0.6 Tons/ha.

TABLE 14
Different combinaison effects of organo-mineral fertilizers with a LIOR
basis on corn grain yield for three high phosphorus saturation sites
(Montmagny, St-Francois, Ste-Madeleine)

| Treatment | Yield | Grain Moisture | Density |
|---|---|---|---|
| kg P₂O₅/ha | Tons/ha | % | g/L |
| 0 (Refefence) | 8.213 | 34.58 | 776 |
| 20 (0% LIOR) | 8.441 | 33.05 | 772 |
| 20 (25% LIOR) | 8.594 | 34.22 | 776 |
| 20 (50% LIOR) | 9.068 | 34.07 | 776 |
| 20 (75% LIOR) | 9.065 | 34.33 | 776 |
| 20 (100% LIOR) | 8.874 | 34.62 | 775 |
| Error mean square | 0.49 | 2.42 | 8.06 |
| Variation factor | 5.47 | 7.08 | 1.04 |
| (%) | | | |

F Value

| | | | |
|---|---|---|---|
| Site effect | 141.90** | 65.90* | 16.14* |
| Treatment effect | 4.21** | 0.68 ns | 0.95 ns |
| Block effect | 4.86** | 1.47 ns | 4.13* |
| Site * Block | 8.52** | 0.58 ns | 2.77* |
| Site * Treatment | 1.03 ns | 0.95 ns | 0.86 ns |
| Reference vs | 10.85** | 0.46 ns | 0.12 ns |
| fertilized | | | |
| Linear effect (% | 6.54** | 2.14 ns | 1.90 ns |
| LIOR) | | | |
| Quadratic effect | 3.55 ns | 0.27 ns | 2.64≈ |
| (% LIOR) | | | |
| Cubic effect (% | 0.95 ns | 0.38 ns | 0.02 ns |
| LIOR) | | | |

### EXAMPLE 6

### Determination of the Effect of the Composition of A DBM-Based OMF on Potatoe Growth

To determine the effect of different combinations of biosolids and mineral fertilizers on the growth of potatoes, bio-treated manure was mixed to mineral fertilizers rich in N (32-0-0), P (8-25-3) or K(6-0-30), in different proportions. The parameters of the experimentation are described in Table 15.

TABLE 15
2001 characteristics of potatoes cultivated soils, cultural parameters and
sample dates

| Parameters | Sainte-Croix | Saint-Ubalde |
|---|---|---|
| Cultivar | GoldRush | GoldRush |
| Sowing date | May 21 | May 17 |
| Foliar sample date | July 13 | July 18 |
| Ridging date | July 6 | July 11 |
| Soil sample date | May 21 | August 14 |
| Harvesting date | September 18 | September 8 |
| Soil series | Tilly | Bevin |
| Texture | Slimy loam | Sandy loam |
| Clay (%) | 21.0 | 6.5 |
| MO (%) | 3.9 | 4.9 |
| pH (0.01 M CaCl₂) | 5.10 | 5.35 |
| Buffer pH | 6.12 | 6.28 |
| P_{M-III} (mg/kg) | 21.6 | 79.2 |
| A1_{M-III} (mg/kg) | 1441.0 | 1760.5 |
| 100(P/A1)_{M-III} (%) | 1.5 | 4.5 |

Result

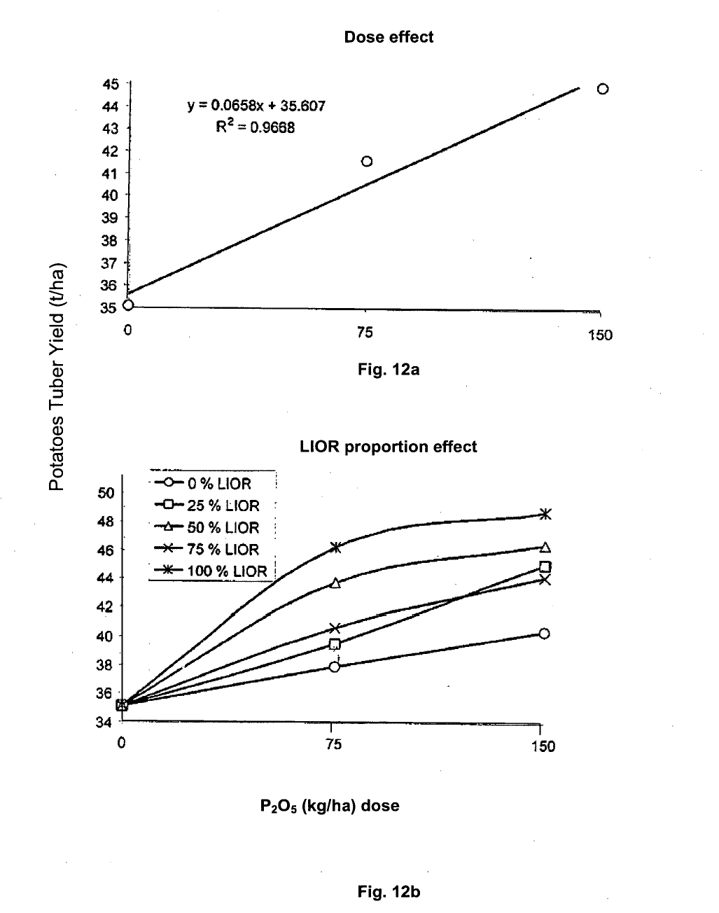

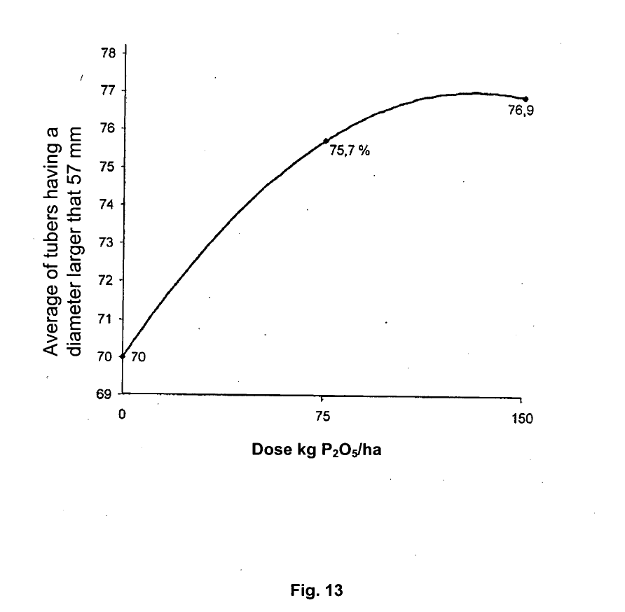

The effect of the different combinations of organo phosphatic fertilizer is shown in Table 16 and FIGS. 12 and 13. Results show that 50% LIOR increases the yield of potatoes by approximately 6 tons/ha at both 75 and 150 kg P₂O₅/ha, which represents a 15% increase of the potatoes productivity.

TABLE 16
Dose and different combination of organo-mineral fertilizers
with a LIOR basis effect on yield and specific weights
of potatoes cultivation (cultivar Gold Rush, St-Ubalde)

| Treatment | Yield | | Tuber category >57 mm |
|---|---|---|---|
| kg P₂O₅/ha | Tons/ha | Specific weight | % |
| 0 (Refefence) | 35.079 | 1.075 | 70.0 |
| 75 (0% LIOR) | 37.864 | 1.073 | 75.2 |
| 75 (25% LIOR) | 39.505 | 1.072 | 76.4 |
| 75 (50% LIOR) | 43.735 | 1.070 | 76.4 |
| 75 (75% LIOR) | 40.625 | 1.070 | 78.7 |
| 75 (100% LIOR) | 46.255 | 1.070 | 75.3 |
| 150 (0% LIOR) | 40.433 | 1.074 | 76.0 |
| 150 (25% LIOR) | 45.033 | 1.072 | 75.9 |
| 150 (50% LIOR) | 46.420 | 1.073 | 78.0 |
| 150 (75% LIOR) | 44.128 | 1.072 | 75.8 |
| 150 (100% LIOR) | 48.728 | 1.069 | 75.3 |
| Error mean square | 4.40 | 0.004 | 4.06 |
| Variation factor (%) | 10.34 | 0.37 | 5.36 |
| | F Value | | |
| Treatment effect | 3.56** | 0.92 ns | 1.16 ns |
| Block effect | 5.88** | 2.47≈ | 1.51 ns |
| Reference vs | 12.62** | 3.59≈ | 8.72** |
| fertilized | | | |
| Dose effect | 7.93** | 0.27 ns | 0.02 ns |
| Linear dose | 17.75** | 2.77≈ | 7.76** |
| Quadratic dose | 0.56 ns | 3.08≈ | 5.23** |
| Linear effect (% | 7.31** | 3.16≈ | 0.02 ns |
| LIOR) | | | |
| Quadratic effect (% | 1.42 ns | 0.00 ns | 1.21 ns |
| LIOR) | | | |
| Cubic effect (% | 1.56 ns | 0.26 ns | 0.29 ns |
| LIOR) | | | |

### EXAMPLE 7

### Determination of the Effect of the Composition of A Lior-Based OMF on Soy Growth

To determine the effect of different combinations of biosolids and mineral fertilizers on the growth of soy, bio-treated manure was mixed to mineral fertilizers rich in N (32-0-0), P (8-25-3) or K(6-0-30), in different proportions. The parameters of the experimentation are described in Table 17 and Table 18.

TABLE 17
2001 characteristics
of soy cultivated soils, cultural parameters and sample dates

| Parameters | Yvon Dion | Bernard Fontaine |
|---|---|---|
| Locality | St-Damase | St-Barnabé-Sud |
| Cultivar | Grand-Prix | Prograin Ohgata |
| UTM | 2700 | 2625 |
| Soil sample date | September 7 | September 7 |
| Harvesting date | September 7 | September 7 |
| Soil series | Ste-Rosalie | St-Hyacinthe |
| Texture | Sandy-argillaceous loam | Slimy loam |
| Clay (%) | 20.9 | 17.8 |
| MO (%) | 2.1 | 2.1 |
| pH (0.01 M CaCl₂) | 5.58 | 5.62 |
| buffer pH | 7.04 | 7.06 |
| P_{M-III} (mg/kg) | 157.2 | 106.1 |
| A1_{M-III} (mg/kg) | 564.1 | 645.0 |
| 100(P/A1)_{M-III} (%) | 27.9 | 16.5 |

TABLE 18
2001 soy fertilization treatment at St-Damase and St-Barnabé South

| | | | MAP | LIOR | | |
|---|---|---|---|---|---|---|
| | | P Dose | proportion | proportion | N | K₂O |
| Treatment | P Form | kg P₂O₅/ha | % | | kg N/ha | kg K₂O/ha |
| A | (reference) | 0 | 0 | 0 | 20 | 30 |
| B | MAP | 20 | 100 | 0 | 20 | 30 |
| C | MAP + LIOR | 20 | 75 | 25 | 20 | 30 |
| D | MAP + LIOR | 20 | 50 | 50 | 20 | 30 |
| E | MAP + LIOR | 20 | 25 | 75 | 20 | 30 |
| F | LIORP | 20 | 0 | 100 | 20 | 30 |

Results

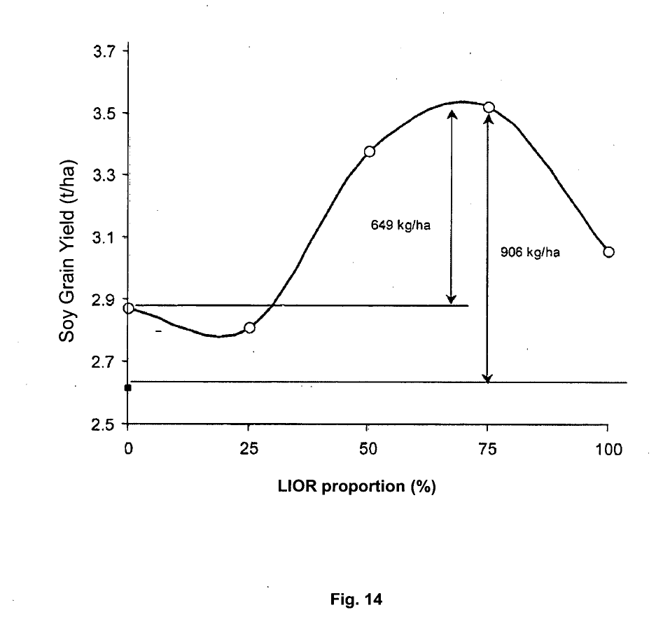

The effect of the different combinations of organo phosphatic fertilizer is shown in Table 19 and FIG. 14. Results show that 75% LIOR increases the yield of soy by approximately 0.6 tons/ha, which represents a 21% increase of the soy productivity.

TABLE 19
Different combination of organo-mineral fertilizers
with a LIOR basis effects on soy cultivation for the 2 sites
(St-Barnabé South and St-Damase)

| Treatment | Yield | Density |
|---|---|---|
| kg P₂O₅/ha | Tons/ha | g/L |
| 0 (Refefence) | 2.61 | 1.360 |
| 20 (0% LIOR) | 2.85 | 1.381 |
| 20 (25% LIOR) | 2.81 | 1.359 |
| 20 (50% LIOR) | 3.47 | 1.364 |
| 20 (75% LIOR) | 3.44 | 1.372 |
| 20 (100% LIOR) | 3.18 | 1.365 |
| Error mean square | 0.49 | 0.02 |
| Variation factor (%) | 15.94 | 1.60 |

F Value

| | | |
|---|---|---|
| Site effect | 10.13** | 0.07 ns |
| Treatment effect | 4.24** | 1.16 ns |
| Block effect | 3.81** | 0.23 ns |
| Site*block | 0.03 ns | 0.89 ns |
| Site*treatment | 0.67 ns | 0.14 ns |
| Reference vs fertilized | 7.63** | 0.93 ns |
| Linear effect (% LIOR) | 3.61ten | 0.67 ns |
| Quadratic effect (% | 4.61* | 1.38 ns |
| LIOR) | | |
| Cubic effect (% LIOR) | 3.92* | 2.79 tn |

Experiments we conducted experiments since 1999 to determine the efficiency of a different OMF formula on the growth of different crops. OMF comprising 10 to 90% of LIOR were tested. The mineral fertilizer MAP (11-48-0) and bi-ammonium phosphate (18-46-0) were used to complete the OMF. Results demonstrated that an OMF comprising 80% (w/w) of BDM and 20% (w/w) of a mineral fertilizer is preferable.

The 80% BDM-20% mineral fertilizer formula was tested on crops for a summer season. The 20% portion of mineral fertilizer comprised an equal amount of DAP and MAP. For example, 1 kg of BDM was supplemented with 145 grams of DAP and 145 gram of MAP. A commonly used binding agent have been added to the previous mixture (5% w/w of Min-U-Gel® 200 from Floridin, Quincy, Fla., USA) to strengthen the bounds between every component of the pellet. Water have been added to the mixture to facilitate the homogenization, after which the mixture was extruded and dried for 24 hours.

Indeed, it respects the general rules regarding the chemical fertilizer relating to the nutrient composition since it comprise more than 24% of the combined macronutrient nitrogen (N), phosphorus (P₂O₅) and potassium (K). Moreover, the OMF of the present invention can provide an important amount of oligoelements required for the growth of crops (Cu, Zn, Boron, Molybdene, Manganese) since it is manure-based. The presence of binding agents, such as humic acids and fulvic acids, in the BDM represent a advantage of the OMF since they reversebly bind phosphorus, therefore facilitating its absorbtion by plant roots. The binding of phosphorus to humic or fulvic acids prevent its binding to iron or aluminum oxides, a process commonly observed in different types of soil.

While the invention has been described in connection with specific embodiments thereof, it will be understood that it is capable of further modifications and this application is intended to cover any variations, uses, or adaptations of the invention and including such departures from the present disclosure as come within known or customary practice within the art to which the invention pertains and as may be applied to the essential features hereinabove set forth, and as follows in the scope of the appended claims.

1. A pig manure-based organo phosphatic fertilizer that comprises 40% to 90% (w/w) of treated pig manure and 10% to 60% (w/w) of a mineral fertilizer.

2. The organo phosphatic fertilizer of claim 1, wherein said organo phosphatic fertilizer comprises 50% to 80% (w/w) of said treated pig manure and 20% to 50% (w/w) of a mineral fertilizer.

3. The organo phosphatic fertilizer of claim 1, wherein said treated pig manure is obtained by aerobic treatment, anaerobic treatment, biofiltration, composting chemical treatment, thermal treatment or physico-chemical treatment, said treatment being carried out under conditions to stabilize said pig manure and make it odorless.

4. The organic mineral fertilizer of claim. 1, wherein said mineral fertilizer comprises urea, monoammonium phosphate (MAP), diammonium phosphate (DAP), ammonia, magnesium sulfate, magnesium chloride, magnesium silicate, dolomite or chrysotyle.

5. The organo phosphatic fertilizer of claim 1, wherein said organo phosphatic fertilizer comprises 0% to 5% (w/w) of a binding agent.

6. The organo phosphatic fertilizer of claim 5, wherein said organo phosphatic fertilizer comprises 0.5% to 2% (w/w) of a binding agent.

7. The organic mineral fertilizer of claim 5, wherein said binding agent is a zeolite, a silica, an attapulgite clay, a bentonite, or a polymer.

8. The organic mineral fertilizer of claim 7, wherein said binding agent is Min-U-Gel® 200, Cal-Ben™, Microsorb® LVM, Microsorb® RVM, or Attagel®.

9. The organo phosphatic fertilizer of claim 1, wherein said organo phosphatic fertilizer is a solid fertilizer.

10. The organo phosphatic fertilizer of claim 9, wherein said solid fertilizer is in the form of pellets, granules, powders or crumbs.

11. A method for preparing a pig manure-based organo phosphatic fertilizer, which comprises:
a) treating pig manure
b) optionally, dehydrating the manure of step a);
c) mixing the pig manure of step b) to a mineral fertilizer in a proportion of 40% to 90% of said pig manure for 10 to 60% of said mineral fertilizer;
d) pelletizing the mixture of step c).

12. The method of claim 11, wherein said organo phosphatic fertilizer comprises 50% to 80% (w/w) of said pig manure and 20% (w/w) of a mineral fertilizer.

13. The method of claim 11, wherein said treated pig manure is obtained by aerobic treatment, anaerobic treatment, biofiltration, composting chemical treatment, thermal treatment or physico-chemical treatment.

14. The method of claim 11, wherein said mineral fertilizer comprises urea, monoammonium phosphate (MAP), diammonium phosphate (DAP), ammonia, magnesium sulfate, magnesium chloride, magnesium silicate, dolomite or chrysotyle.

15. The method of claim 11, wherein said method further comprises adding 0% to 5% (w/w) of a binding agent prior pelletization.

16. The method of claim 15 wherein said method comprises adding 0.5% to 2% (w/w) of a binding agent.

17. The method of claim 15, wherein said binding agent is a zeolite, a silica, an attapulgite clay, a bentonite, or a polymer.

18. The method of claim 17, wherein said binding agent is Min-U-Gel® 200, Cal-Ben™, Microsorb® LVM, Microsorb® RVM, or Attagel®.
